(19) United States
(12) Patent Application Publication
(10) Pub. No.: US 2026/0304362 A1
(43) Pub. Date: Oct. 1, 2026

(54) DISTRIBUTED TRAINING METHOD, SYSTEM, TERMINAL AND BASE STATION

(71) Applicants: China Telecom Corporation Limited Beijing Research Institute, Beijing (CN); CHINA TELECOM CORPORATION LIMITED, Beijing (CN)

(72) Inventors: Bei YANG, Beijing (CN); Wei LI, Beijing (CN); Xiaoming SHE, Beijing (CN); Peng CHEN, Beijing (CN); Jianxiu WANG, Beijing (CN)

(21) Appl. No.: 19/490,196

(22) PCT Filed: Jun. 5, 2024
(86) PCT No.: PCT/CN2024/097390

§ 371 Date: Dec. 4, 2025

(30) Foreign Application Priority Data
Jun. 5, 2023 (CN) 202310658195.8

(51) Int. Cl. H04W 64/00; G06N 3/098

(52) U.S. Cl. CPC H04W 64/00; G06N 3/098

(57) ABSTRACT

The present disclosure relates to a distributed training method, which includes: a terminal sends a first message to a base station, the terminal being a distributed node for distributed learning, the base station being a central node for distributed learning, and the first message comprising training information for a model deployed by the terminal; and the terminal receives a second message sent by the base station, the second message comprising at least one of a parameter update instruction and a convergence condition update instruction of the model, or comprising a training stop instruction, the first message and the second message being control channel signalings and being scrambled by using a scrambling code sequence, and the scrambling code sequence being determined according to at least one of a model function, a model identifier, a training mode and a training group to which the terminal belongs.

### CROSS REFERENCE TO RELATED APPLICATIONS

The present application is a U.S. National Stage Application of International Application No. PCT/CN2024/097390, filed on Jun. 5, 2024, which is based on and claims the benefit of and priority to Chinese Patent Application No. 202310658195.8, filed on Jun. 5, 2023, where the contents of both of which are incorporated by reference in their entireties herein.

### TECHNICAL FIELD

The present disclosure relates to the field of wireless communications and, in particular, to a distributed training method and system, a terminal, and a base station.

### BACKGROUND

The 3rd Generation Partnership Project (3GPP) Release 18 (Rel-18) investigates key wireless Artificial Intelligence (AI) air-interface technologies, with a focus on centralized machine learning and AI-enabled air interface applications.

AI- and machine-learning-based positioning enhancement technologies can address the limitations of traditional and often inaccurate indoor positioning methods, particularly in challenging Non Line of Sight (NLOS) environments. These approaches are especially beneficial in dense industrial scenarios, such as in 3GPP Indoor Factory with High Base Station Height (InF-DH) environments, where traditional positioning accuracy often degrades to worse than 15 meters.

Conventional indoor positioning technologies estimate user locations based on direct or indirect line of sight measurements from multiple sites. Although these methods can achieve high accuracy under favorable deployment conditions, they depend heavily on the availability of Line of Sight (LOS) paths. Industrial environments typically contain numerous obstacles that cause signal refraction, reflection, and diffraction. Furthermore, multipath propagation and long latency during signal propagation make it difficult for traditional positioning methods to achieve high-precision positioning in such settings.

Deep learning algorithms have advanced rapidly in recent years and have been widely adopted due to their strong performance across various fields. Typical advantages of deep learning methods include efficient raw data processing, automatic feature extraction capabilities, acceleration capabilities of Graphics Processing Units (GPUs), etc. Based on current 3GPP research and evaluation results, AI/ML-based approaches can significantly improve positioning accuracy in indoor heavy NLOS scenarios, including both direct and indirect positioning methods.

### SUMMARY

According to a first aspect of some embodiments of the present disclosure, there is provided a distributed training method, including: sending, by a terminal, a first message to a base station, wherein the terminal is a distributed node of distributed learning, the base station is a central node of the distributed learning, and the first message includes training information of a model deployed on the terminal; and receiving, by the terminal, a second message sent by the base station, wherein the second message includes at least one of a parameter update indication or a convergence condition update indication of the model, or includes a training stop indication; wherein the first message and the second message are control channel signaling and are scrambled with a scrambling sequence, and the scrambling sequence is determined according to at least one of a model function, a model identity, a training mode, or a training group to which the terminal belongs.

According to a second aspect of some embodiments of the present disclosure, there is provided a distributed training method, including: receiving, by a base station, a first message sent by any one of multiple terminals, wherein the multiple terminals are distributed nodes of distributed learning, the base station is a central node of the distributed learning, and the first message includes training information of a model deployed on a terminal; and sending, by the base station, a second message to any one of the multiple terminals, wherein the second message includes at least one of a parameter update indication or a convergence condition update indication of the model, or includes a training stop indication; wherein the first message and the second message are control channel signaling and are scrambled with a scrambling sequence, and the scrambling sequence is determined according to at least one of a model function, a model identity, a training mode, or a training group to which the terminal belongs.

According to a third aspect of some embodiments of the present disclosure, there is provided a terminal, including: a memory; and a processor coupled to the memory, wherein the processor is configured to execute, based on instructions stored in the memory, any distributed training method as described above.

According to a fourth aspect of some embodiments of the present disclosure, there is provided a base station, including: a memory; and a processor coupled to the memory, wherein the processor is configured to execute, based on instructions stored in the memory, any distributed training method as described above.

Other features and advantages of the present disclosure will become apparent from the following detailed description of example embodiments of the present disclosure with reference to the accompanying drawings.

### BRIEF DESCRIPTION OF THE DRAWINGS

In order to more explicitly explain embodiments of the present disclosure or technical solutions in the prior art, the accompanying drawings required to be used in the description of the embodiments or the prior art will be briefly introduced below. It is apparent that the accompanying drawings illustrated below are merely some of the embodiments of the present disclosure. For those of ordinary skill in the art, other accompanying drawings may also be obtained according to these accompanying drawings on the premise that no inventive effort is involved.

FIG. 1 shows a schematic structural diagram of a distributed training system according to some embodiments of the present disclosure.

FIG. 2 shows a schematic flowchart of a distributed training method according to some embodiments of the present disclosure.

FIG. 3 shows a schematic flowchart of a configuration method according to some embodiments of the present disclosure.

FIG. 4 shows a schematic flowchart of an indoor positioning method according to some embodiments of the present disclosure.

FIG. 5 shows a schematic structural diagram of a terminal according to some embodiments of the present disclosure.

FIG. 6 shows a schematic structural diagram of a base station according to some embodiments of the present disclosure.

FIG. 7 shows a schematic structural diagram of an electronic device according to some embodiments of the present disclosure.

FIG. 8 shows a schematic structural diagram of an electronic device according to some other embodiments of the present disclosure.

### DETAILED DESCRIPTION

The technical solutions in embodiments of the present disclosure will be described clearly and completely with reference to the drawings in the embodiments of the present disclosure, and it is apparent that the embodiments described are only some, but not all, of the embodiments of the present disclosure. The following description of at least one example embodiment is merely illustrative and is in no way intended to limit the disclosure or its application or uses. All other embodiments which are derived by those skilled in the art from the embodiments disclosed herein without inventiveness fall within the scope of the present disclosure.

The relative arrangement of parts and steps, numerical expressions and numerical values set forth in these embodiments do not limit the scope of the present disclosure unless specifically stated otherwise.

Meanwhile, it should be understood that, for the convenience of description, sizes of respective portions shown in the drawings are not drawn in an actual proportional relationship.

Techniques, methods, and devices known to one of ordinary skill in the relevant art may not be discussed in detail but are intended to be part of the specification where appropriate.

In all examples shown and discussed herein, any particular value should be construed as illustrative only and not as limiting. Thus, other examples of the example embodiments may have different values.

It should be noted that: similar reference numbers and letters refer to similar items in the following figures, and thus, once an item is defined in one figure, it need not be discussed further in subsequent figures.

Analysis shows that the current AI/ML-based positioning enhancement scheme in 3GPP is a centralized training scheme. This requires centralizing data used for AI/ML model training on a base station, terminal, or Location Management Function (LMF) side, which requires large amounts of training data sets (such as measurement signals) to be transmitted across air interfaces or interfaces, resulting in high transmission overhead.

A technical problem to be solved by embodiments of the present disclosure is: how to reduce the overhead in a model training process.

The inventors realized that this problem can be solved by using a distributed framework to reduce data information transmission across the air interfaces/interfaces.

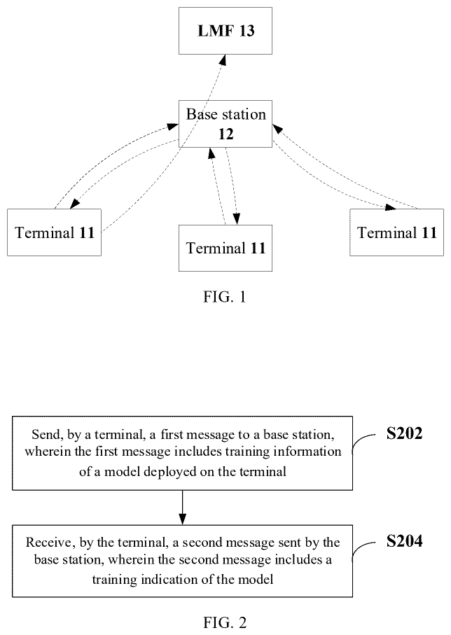

FIG. 1 shows a schematic structural diagram of a distributed training system according to some embodiments of the present disclosure. As shown in FIG. 1, network scenario 1 includes multiple terminals 11 and a base station 12. The terminals 11 are distributed nodes that train locally deployed models and report training information to the base station 12. The base station 12 is a central node that aggregates information reported by respective terminals 11 and updates model parameters. When the base station includes a Centralized Unit (CU) and a Distributed Unit (DU), the central node can also be deployed in either the CU or the DU, thereby reducing the data information transmission across the air interfaces/interfaces. In some embodiments, a LMF 13 can also be provided to perform inference after model training is completed, so as to obtain prediction results, for example, perform inference on an indoor positioning model to determine a user's location. As needed, the terminal 11 can also perform inference and send a model output to the LMF 13, which then determines the user's location based on the model output.

Embodiments of the distributed training method in the present disclosure are described below with reference to FIG. 2.

FIG. 2 shows a schematic flowchart of a distributed training method according to some embodiments of the present disclosure. As shown in FIG. 2, the distributed training method of the embodiment includes steps S202 and S204.

In the step S202, a terminal sends a first message to a base station, the terminal is a distributed node of distributed learning, the base station is a central node of the distributed learning, and the first message includes training information of a model deployed on the terminal.

In some embodiments, the training information includes parameter of the model after training, or training status of the model.

The parameter of the model after training can be, for example, represented in the form of key-value pairs, that is, including a name of each parameter and its value. Alternatively, data consisting of values of individual parameters, such as matrices, vectors, etc., can be sent directly in a default format. A parameter name corresponding to an element at each position can be preset to further save transmission resources.

The training status of the model indicates whether the terminal has completed the current round of training of the model. For example, when the terminal detects that the current model meets a convergence condition (the maximum number of iterations has been reached, a value of a loss function is less than a pre-configured threshold, etc.), the terminal reports to the base station that the current training has ended.

In the step S204, the terminal receives a second message sent by the base station, and the second message includes at least one of a parameter update indication or a convergence condition update indication of the model, or includes a training stop indication. The parameter update indication, the convergence condition update indication and the training stop indication may be collectively referred to as a training indication.

The parameter update indication is an updated parameter value obtained by the base station after aggregating the training information reported by the terminals where multiple distributed nodes are located. Then, the base station can send the updated parameter value to the terminals where the respective distributed nodes are located.

The training stop indication is used to indicate to the terminal to stop the training process, which can be sent by the base station in response to determining that the converged model meets the convergence condition.

The convergence condition update indication is used to notify the terminal that the convergence condition has been updated and to inform the terminal of a new convergence condition.

The terminal and the base station can interact through control channel signaling, for example, the first message is uplink control information, and the second message is downlink control information. Embodiments of the present disclosure design an implementation of the control channel signaling.

The control channel signaling is scrambled using a scrambling sequence. First, a method for generating the scrambling sequence used for the control channel signaling can be defined for an application scenario where the base station and the terminal perform distributed training. The base station and the terminal can learn that the corresponding control information is training-related information according to different scrambling codes of signaling carried on demodulation control channels. The scrambling sequence is represented by a Model Training-Radio Network Temporary Identifier (MT-RNTI) in the following, and other names may also be used as needed, which will not be detailed here.

In some embodiments, all terminals in the same training group may use a unified MT-RNTI (that is, a default scrambling sequence corresponding to the distributed learning) for their own training process.

In some embodiments, the scrambling sequence is determined according to the training mode, that is, different training modes are distinguished by different MT-RNTIs. For example, MT-C-RNTI is used for centralized model training, and MT-D-RNTI is used for distributed model training. Alternatively, supervised training and unsupervised training are distinguished by different scrambling sequences.

In some embodiments, the scrambling sequence is determined according to a model function or a model identity. The model function represents, for example, at least one of mobility optimization, positioning, or beam management. The model identity is represented, for example, by a model ID, where each model has a unique ID. Accordingly, the model training for different model functions or model IDs have different MT-RNTIs. The MT-RNTI is generated in a manner calculated or derived from the model function or the model ID.

In some embodiments, the scrambling sequence is determined according to the training group to which the terminal belongs. That is, terminals in the same training group use the same MT-RNTI. The training group is a group consisting of terminals belonging to the same training task.

Therefore, whether it is a base station or a terminal, after receiving the control channel signaling sent by the other party, it can learn that the corresponding control information is relevant information about the model training such as the model function, the model identity, the training mode, the training group, etc. according to the different scrambling codes of the signaling carried on the demodulation control channel.

Then, dedicated signaling formats can be defined for the first and second messages. For example, the first message is the uplink control information and has a first signaling format determined according to the scrambling sequence, and the second message is the downlink control information and has a second signaling format determined according to the scrambling sequence. Each signaling format can predefine at least one of one or more fields and a field size.

The first signaling format and the second signaling format include at least one field of the model identity, a model function identity, a timestamp, a sequence index, or a training group identity.

The second signaling format may further include at least one field of an aggregation method indication, a training stop condition, an initial value of a parameter of the model, the parameter update indication of the model, or a gradient update indication of the model.

In some embodiments, any one of the parameter update indication and the gradient update indication of the model includes an indication bit, and a value of the indication bit is different from a value of the indication bit in the same indication obtained by the terminal last time, so as to avoid the terminal confusing the contents of two adjacent indications.

The value of the indication bit is a first value and a second value. For example, an optional value of the indication bit includes 0 and 1. The indication bits in the parameter update indication and the gradient update indication of the model sent each time are obtained by inverting the indication bit in the indication sent last time. The value of the indication bit can also be other values or includes other optional values as needed, which will not be detailed here.

In some embodiments, sizes of fields in the first signaling format and the second signaling format are default values, for example, determined in a standard predefined manner; or the sizes of the fields in the first signaling format and the second signaling format are determined according to a configuration sent by the base station.

Embodiments of the present disclosure are applicable to model training methods in the distributed wireless network architecture of 5G-Advanced and 6G networks, and define the physical layer signaling of the air interface required for the model training. Through the distributed architecture and the interaction processes, the terminal can train the locally deployed model and only inform the base station of the training information rather than all the information of the model, thereby saving air interface or interface resources. The base station can reduce the local computing pressure by aggregating the training information provided by individual terminals. Therefore, the embodiments of the present disclosure improve the prediction accuracy, generalization, and convergence speed of the model, and reduce communication overhead.

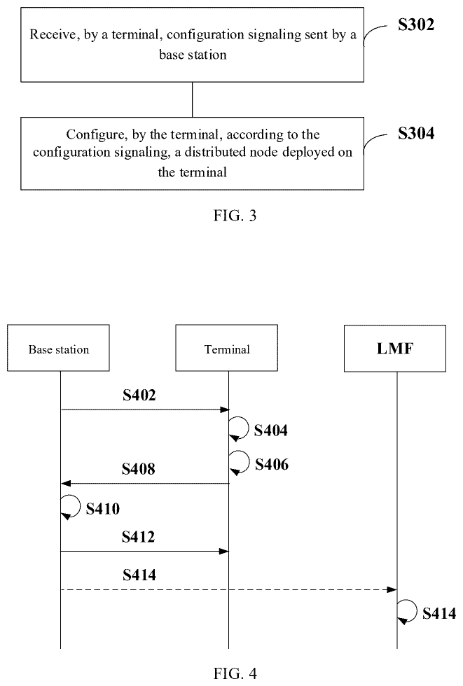

In embodiments of the present disclosure, the configuration can also be performed by the base station for the terminal. Embodiments of the configuration method of the present disclosure are described below with reference to FIG. 3.

FIG. 3 shows a schematic flowchart of a configuration method according to some embodiments of the present disclosure. As shown in FIG. 3, the configuration method of the embodiment includes steps S302 and S304.

In the step S302, the terminal receives configuration signaling sent by the base station, and the configuration signaling includes at least one of the model function, the model identity, the model configuration, or a training data collection configuration.

The configuration signaling can be sent through higher layer signaling such as Radio Resource Control (RRC) signaling and Media Access Control Control Element (MAC CE) signaling, or through Downlink Control Information (DCI) of a physical layer.

In some embodiments, the model function represents at least one of mobility optimization, positioning, or beam management.

The model function can be reflected as a model function identification code, which includes more relevant information in addition to the model function, and can be an M-bit string, including at least one of a model function identity, an area code, a Public Land Mobile Network (PLMN), an operator identification code, a Tracking Area (TA), a cell group, or a geographic range identification code.

The model identity can be reflected as an M-bit string, which includes more relevant information in addition to the model identity, including at least one of a country identification code, the operator identification code, the PLMN, the TA, the geographic range identification code, or the model identification code (for example, different models within a country).

In some embodiments, the model configuration includes a model lifecycle management configuration or a model attribute configuration.

The model lifecycle management configuration reflects configurations required for individual stages of model training, for example, including at least one of a model training configuration, a model inference configuration, a model deployment configuration, a model update configuration, or a model monitoring configuration.

The model attribute configuration includes, for example, at least one of an input configuration, an output configuration, a model structure configuration, an interface configuration, or a training rule configuration. For example, the terminal receives MLModelTrainingConfiguration sent by the base station, which includes a TrainingType information element, configured as FederalLearning, and also includes a ModelInput information element, a ModelOutput information element, a ModelStructure information element, a TrainingRule information element, etc.

The input configuration and the output configuration include, for example, the number of data dimensions and a model input type (real/complex/integer/float16/float32/ quantization level, etc.). Taking the input information element ModelInput as an example, a configuration model for this information element uses a one-dimensional data input and employs a multi-layer perceptron (MLP) model for Time of Arrival (TOA), Down link Time Difference Of Arrival (DL-TDOA) and Reference Signal Receiving Power (RSRP) information. An input of the model is measurement information such as TOA, DL-TDOA, and RSRP. The data input dimension is 1×18 (18 is the number of preset base stations), representing a user receiving downlink reference signals sent by 18 base stations and performing channel estimation. Taking the output information element ModelOutput as an example, an output of its configuration model is a predicted two-dimensional coordinates (x, y) of the terminal, where each coordinate is a float16 real number.

The model structure configuration includes, for example, the model type (a deep neural network (DNN), a convolutional neural network (CNN), a transformer (Transformer), a residual network (Resnet), etc.), the number of layers, the number of nodes, an activation function type (a rectified linear unit (ReLu), a leaky rectified linear unit (LeakyRelu), etc.) and the like. For example, the information element ModelStructure configures the model structure. This configured model uses a three dimensional data input and extracts, based on the residual network (Resnet), a feature of three dimensional Channel Impulse Response (CIR) data. Each CIR sample is multidimensional matrix information with input dimensions of 18×256×2, and each element is a complex floating-point number of type float32. This three dimensional input is generated using CIR information of 18 base stations and 256 Fast Fourier Transform (FFT) sampling points received by the terminal, where 2 represents the real and imaginary parts of the complex number. In the first four Reshape layers of the model, the CIR input is converted to a size of 18×18×64, followed by convolution operations being performed on 12 two-dimensional convolution (Con2D) layers and 3×3 convolution kernels, and shortcut operations being performed between specific layers.

The interface configuration is, for example, a model interface standardized file or a file type, including Open Neural Network Exchange (ONNX), Torchscript, etc. The standardized file refers to, for example, a model format file with a suffix of .onnx.

The training rule configuration includes, for example, an optimization objective function (a normalized mean square error (NMSE), a cross entropy, etc.), the learning rate, a specific method used for gradient descent, etc.

Notably, the specific implementations described above are only illustrative, and those skilled in the art may adopt other specific implementations as needed, which will not be described in detail here.

In some embodiments, the training data collection configuration includes at least one of a collection object or a collection method. The collection object is, for example, a type of information collected, and the collection method is, for example, what kind of signal is processed in what way.

For example, the training data collection configuration may indicate to the terminal to measure a reference signal such as a downlink Positioning Reference Signal (PRS), a Channel State Information Reference Signal (CSI-RS) or the like to obtain the CIR information, the RSRP, etc.

In some embodiments, the training data collection configuration includes a configuration for uplink measurement of the reference signal.

For example, the terminal receives the reference signal which is required for uplink measurement and is configured by the network side, and the network obtains measurement information such as CIR, TDOA, and TOA through the uplink measurement. For example, it is indicated that measurement data of a terminal is reported to a single base station (such as a primary cell) or multiple base stations (such as base stations in a secondary cell group).

In some embodiments, the training data includes at least one of labeled data or unlabeled data. That is, the collected training data can be the labeled data, the unlabeled data, or both.

In the step S304, the terminal configures, according to the configuration signaling, a distributed node deployed on the terminal.

Through the above embodiments, different parameters can be configured for the terminal based on different scenarios, cells, TAs, etc., thereby improving the flexibility of the distributed training.

Referring to FIG. 4, an interaction process between the terminal and the base station is described below by taking the indoor positioning model as an example.

FIG. 4 shows a schematic flowchart of an indoor positioning method according to some embodiments of the present disclosure. As shown in FIG. 4, the indoor positioning method of the embodiment includes steps S402 to S414.

In the step S402, the base station as the central node sends a configuration message to the terminal as the distributed node.

In the step S404, the terminal configures the distributed node according to the configuration message.

In the step S406, the terminal trains the locally deployed model to obtain training information, and the model is the indoor positioning model.

In the step S408, the terminal sends the training information to the base station through a first message.

In the step S410, in a case where the base station determines that the current model has not converged, the base station updates a model parameter according to training information sent by multiple terminals and sends the updated parameter to the terminal through a second message. Then, the process returns to the step S406, and the terminal continues training based on the updated parameter.

In the step S412, in a case where the base station determines that the current model has converged, the base station sends a training stop indication to the terminal through the second message.

In the step S414, the LMF determines a location of the terminal based on an inference result of the indoor positioning model. The LMF can perform inference on its own, or the terminal can send the prediction result of model after reference to the LMF.

Since the positioning information of the user belongs to private data, the distributed training is used to prevent the positioning information collected by the terminal for training from being leaked, thereby protecting the security and privacy of the positioning-related data.

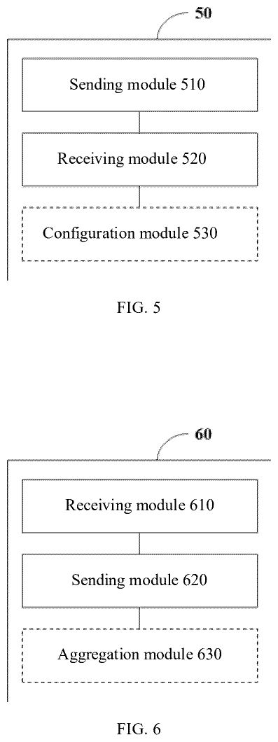

Embodiments of the terminal of the present disclosure will be described below with reference to FIG. 5.

FIG. 5 shows a schematic structural diagram of a terminal according to some embodiments of the present disclosure. As shown in FIG. 5, a terminal 50 of the embodiment includes: a sending module 510, configured to send a first message to a base station, wherein the terminal is a distributed node of distributed learning, the base station is a central node of the distributed learning, and the first message includes training information of a model deployed on the terminal; and a receiving module 520, configured to receive a second message sent by the base station, wherein the second message includes at least one of a parameter update indication or a convergence condition update indication of the model, or includes a training stop indication; wherein the first message and the second message are control channel signaling and are scrambled with a scrambling sequence, and the scrambling sequence is determined according to at least one of a model function, a model identity, a training mode, or a training group to which the terminal belongs.

In some embodiments, the same scrambling sequence is used by multiple terminals in the training group to which the terminal belongs.

In some embodiments, the first message has a first signaling format determined according to the scrambling sequence; and/or the second message has a second signaling format determined according to the scrambling sequence.

In some embodiments, the first signaling format and the second signaling format include at least one field of the model identity, a model function identity, a timestamp, a sequence index, or a training group identity.

In some embodiments, the second signaling format includes at least one field of an aggregation method indication, a training stop condition, an initial value of a parameter of the model, the parameter update indication of the model, or a gradient update indication of the model.

In some embodiments, any one of the parameter update indication of the model and the gradient update indication of the model includes an indication bit, and a value of the indication bit is different from a value of the indication bit in the same indication obtained by the terminal last time.

In some embodiments, the value of the indication bit is a first value or a second value.

In some embodiments, sizes of fields in the first signaling format and the second signaling format are default values, or are determined according to a configuration sent by the base station.

In some embodiments, the training information includes parameter of the trained model, or training status of the model.

In some embodiments, the receiving module 520 is further configured to receive configuration signaling sent by the base station, wherein the configuration signaling includes at least one of the model function, the model identity, a model configuration, or a training data collection configuration; and the terminal 50 further includes a configuration module 530, configured to configure, according to the configuration signaling, the distributed node deployed on the terminal.

In some embodiments, the model function represents at least one of mobility optimization, positioning, or beam management.

In some embodiments, the model function includes at least one of a model function identity, an area code, a public land mobile network, an operator identification code, a tracking area, a cell group, or a geographic range identification code; and/or, the model identity includes at least one of a country identification code, the operator identification code, the public land mobile network, the tracking area, the geographic range identification code, or a model identification code.

In some embodiments, the model configuration includes a model lifecycle management configuration or a model attribute configuration.

In some embodiments, the model lifecycle management configuration includes at least one of a model training configuration, a model inference configuration, a model deployment configuration, a model update configuration, or a model monitoring configuration; and/or, the model attribute configuration includes at least one of an input configuration, an output configuration, a model structure configuration, an interface configuration, or a training rule configuration.

In some embodiments, the training data collection configuration includes at least one of a collection object or a collection method; or, the training data collection configuration includes a configuration for uplink measurement of a reference signal.

In some embodiments, the configuration signaling is any one of downlink control information of a physical layer, a control unit of a media access layer, or radio resource control signaling.

In some embodiments, the distributed learning is federated learning.

In some embodiments, the model is an indoor positioning model.

Embodiments of a base station of the present disclosure are described below with reference to FIG. 6.

FIG. 6 shows a schematic structural diagram of a base station according to some embodiments of the present disclosure. As shown in FIG. 6, a base station 60 of the embodiment includes: a receiving module 610, configured to receive a first message sent by any one of multiple terminals, wherein the multiple terminals are distributed nodes of distributed learning, the base station is a central node of the distributed learning, and the first message includes training information of a model deployed on a terminal; and a sending module 620, configured to send a second message to any one of the multiple terminals, wherein the second message includes at least one of a parameter update indication or a convergence condition update indication of the model, or includes a training stop indication; wherein the first message and the second message are control channel signaling and are scrambled with a scrambling sequence, and the scrambling sequence is determined according to at least one of a model function, a model identity, a training mode, or a training group to which the terminal belongs.

In some embodiments, the base station 60 further includes an aggregation module 630, configured to aggregate, according to training information sent by the multiple terminals, models deployed on the multiple terminals to obtain an updated model parameter.

In some embodiments, the sending module 620 is further configured to send configuration signaling to any one of the multiple terminals, wherein the configuration signaling includes at least one of a model function, a model identity, a model configuration, or a training data collection configuration.

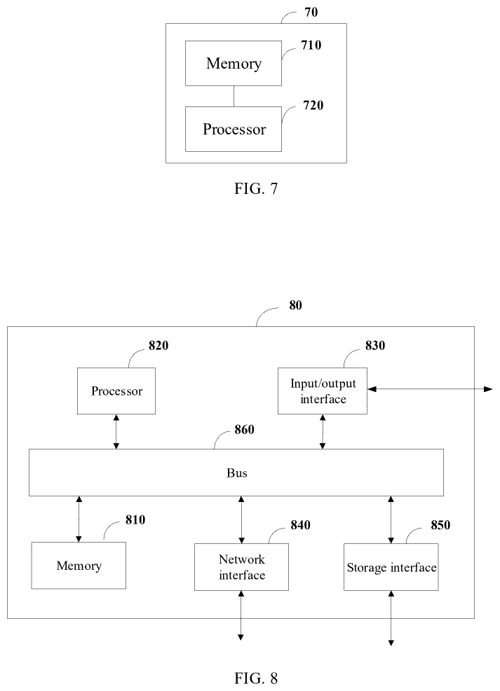

FIG. 7 shows a schematic structural diagram of an electronic device according to some embodiments of the present disclosure, and the electronic device is a base station or a terminal. As shown in FIG. 7, an electronic device 70 of the embodiment includes: a memory 710 and a processor 720 coupled to the memory 710. The processor 720 is configured to execute, based on instructions stored in the memory 710, the distributed training method of any of the aforementioned embodiments.

The memory 710 may include, for example, a system memory, a fixed non-volatile storage medium, etc. The system memory stores, for example, an operating system, an application, a boot loader, and other programs.

FIG. 8 shows a schematic structural diagram of an electronic device according to some other embodiments of the present disclosure, which electronic device is a base station or a terminal. As shown in FIG. 8, an electronic device 80 of the embodiments includes: a memory 810 and a processor 820, and may also include an input/output interface 830, a network interface 840, a storage interface 850, etc. These interfaces 830, 840, 850 and the memory 810 and the processor 820 may be connected through, for example, a bus 860. The input/output interface 830 provides a connection interface for input and output devices such as a display, a mouse, a keyboard, and a touch screen. The network interface 840 provides a connection interface for various networked devices. The storage interface 850 provides a connection interface for external storage devices such as a SD card and a USB disk.

Embodiments of the present disclosure further provide a computer-readable storage medium having a computer program stored thereon, and the program, when executed by a processor, implements any distributed training method as described above.

Those skilled in the art shall understand that embodiments of the present disclosure may be provided as a method, a system, or a computer program product. Therefore, the present disclosure may take the form of complete hardware embodiments, complete software embodiments, or embodiments combining software and hardware aspects. In addition, the present disclosure may also take the form of a computer program product implemented on one or more computer-usable non-transitory storage media (including but not limited to a magnetic disk memory, a CD-ROM, and an optical memory) including computer-usable program codes.

According to embodiments of the present disclosure, there is provided a model training method, including: sending, by a terminal, a first message to a base station, wherein the first message includes training information of a model deployed on the terminal; and receiving, by the terminal, a second message sent by the base station, wherein the second message includes training configuration information of the model.

In some embodiments, the training configuration information includes at least one of a parameter update indication or a convergence condition update indication, or includes a training stop indication.

In some embodiments, the first message and the second message are control channel signaling and are scrambled with a scrambling sequence, and the scrambling sequence is determined according to at least one of a model function, a model identity, a training mode, or a training group to which the terminal belongs.

In some embodiments, the terminal is a model training node, and the base station is a model training node.

In some embodiments, the same scrambling sequence is used by multiple terminals in the training group to which the terminal belongs.

In some embodiments, the first message has a first signaling format determined according to the scrambling sequence; and/or the second message has a second signaling format determined according to the scrambling sequence.

In some embodiments, the first signaling format and the second signaling format include at least one field of the model identity, a model function identity, a timestamp, a sequence index, or a training group identity.

In some embodiments, the second signaling format includes at least one field of an aggregation method indication, a training stop condition, an initial value of a parameter of the model, the parameter update indication of the model, or a gradient update indication of the model.

In some embodiments, any one of the parameter update indication of the model and the gradient update indication of the model includes an indication bit.

In some embodiments, a value of the indication bit is different from a value of the indication bit in the same indication obtained by the terminal last time.

In some embodiments, the value of the indication bit is a first value or a second value.

In some embodiments, sizes of fields in the first signaling format and the second signaling format are default values, or are determined according to a configuration sent by the base station.

In some embodiments, the training information includes parameter of the trained model, or training status of the model.

In some embodiments, the training method further includes at least one of: receiving, by the terminal, configuration signaling sent by the base station, wherein the configuration signaling includes at least one of the model function, the model identity, a model configuration, or a data collection configuration; and configuring, by the terminal, according to the configuration signaling, the model deployed on the terminal.

In some embodiments, the model function represents at least one of mobility enhancement, positioning, beam management or CSI enhancement.

In some embodiments, the model function includes at least one of a model function identity, an area code, a public land mobile network, an operator identification code, a tracking area, a cell group, or a geographic range identification code; and/or, the model identity includes at least one of a country identification code, the operator identification code, the public land mobile network, the tracking area, the geographic range identification code, or a model identification code.

In some embodiments, the model configuration includes a model lifecycle management configuration or a model attribute configuration or an AI/ML management configuration.

In some embodiments, the model lifecycle management configuration includes at least one of a model training configuration, a model inference configuration, a model deployment configuration, a model update configuration, or a model monitoring configuration; and/or, the model attribute configuration includes at least one of an input configuration, an output configuration, a model structure configuration, an interface configuration, or a training rule configuration.

In some embodiments, the training data collection configuration includes at least one of a collection object or a collection method; or, the training data collection configuration includes a configuration for uplink measurement of a reference signal.

In some embodiments, the configuration signaling is any one of downlink control information of a physical layer, a control unit of a media access layer, or radio resource control signaling.

In some embodiments, the distributed learning is federated learning or two-sided model training or sequential training.

In some embodiments, the model is a positioning model.

The present disclosure is described with reference to flowcharts and/or block diagrams of the method, device (system), and computer program product according to embodiments of the present disclosure. It can be understood that each process and/or block in the flowcharts and/or block diagrams, and combinations of the processes and/or blocks in the flowcharts and/or block diagrams may be implemented by computer program instructions. These computer program instructions may be provided to a general computer, a dedicated computer, an embedded processor, or processors of other programmable data processing devices to generate a machine to enable the instructions to be executed by the computer or the processors of other programmable data processing devices to generate a device for implementing functions defined in one or more processes in the flowcharts, and/or one or more blocks in the block diagrams.

These computer program instructions may also be stored in a computer-readable memory that can direct a computer or other programmable data processing devices to operate in a particular manner, such that the instructions stored in the computer-readable memory generate a product including an instruction device that implements functions defined in one or more processes in the flowcharts, and/or one or more blocks in the block diagrams.

These computer program instructions may also be loaded to the computer or other programmable data processing devices, such that a series of operations or steps are performed on the computer or other programmable devices to generate processing implemented by the computer, and the instructions executed on the computer or other programmable devices thus provide steps for implementing functions defined in one or more processes in the flowcharts, and/or one or more blocks in the block diagrams.

Those described above are only some embodiments of the present disclosure and are not intended to limit the present disclosure. Any modifications, equivalent substitutions, improvements, etc. made within the spirit and principles of the present disclosure shall be included in the protection scope of the present disclosure.

1. A distributed training method, comprising:
sending, by a terminal, a first message to a base station, wherein the terminal is a distributed node of distributed learning, the base station is a central node of the distributed learning, and the first message comprises training information of a model deployed on the terminal; and
receiving, by the terminal, a second message sent by the base station, wherein the second message comprises at least one of a parameter update indication or a convergence condition update indication of the model, or comprises a training stop indication;
wherein the first message and the second message are control channel signaling and are scrambled with a scrambling sequence, and the scrambling sequence is determined according to at least one of a model function, a model identity, a training mode, or a training group to which the terminal belongs.

2. The training method according to claim 1, wherein the same scrambling sequence is used by multiple terminals in the training group to which the terminal belongs.

3. The training method according to claim 1, wherein:
the first message has a first signaling format determined according to the scrambling sequence; or
the second message has a second signaling format determined according to the scrambling sequence.

4. The training method according to claim 3, wherein the first signaling format and the second signaling format comprise at least one field of the model identity, a model function identity, a timestamp, a sequence index, or a training group identity.

5. The training method according to claim 3, wherein the second signaling format comprises at least one field of an aggregation method indication, a training stop condition, an initial value of a parameter of the model, the parameter update indication of the model, or a gradient update indication of the model.

6. The training method according to claim 5, wherein:
any one of the parameter update indication of the model and the gradient update indication of the model comprises an indication bit; and
the value of the indication bit is a first value or a second value.

7. (canceled)

8. The training method according to claim 3, wherein sizes of fields in the first signaling format and the second signaling format are default values, or are determined according to a configuration sent by the base station.

9. The training method according to claim 1, wherein the training information comprises parameter of the model trained, or training status of the model.

10. The training method according to claim 1, further comprising at least one of:
receiving, by the terminal, configuration signaling sent by the base station, wherein the configuration signaling comprises at least one of the model function, the model identity, a model configuration, or a data collection configuration; or
configuring, by the terminal, according to the configuration signaling, the model deployed on the terminal.

11. The training method according to claim 10, wherein the model function represents at least one of mobility enhancement, positioning, beam management of Channel State Information (CSD) enhancement.

12. The training method according to claim 10, wherein:
the model function comprises at least one of a model function identity, an area code, a public land mobile network, an operator identification code, a tracking area, a cell group, or a geographic range identification code; or
the model identity comprises at least one of a country identification code, an operator identification code, a public land mobile network, a tracking area, a geographic range identification code, or a model identification code.

13. The training method according to claim 10, wherein the model configuration comprises a model lifecycle management configuration or a model attribute configuration of an Artificial Intelligence (AI)/Machine Learning (ML) management configuration.

14. The training method according to claim 13, wherein:
the model lifecycle management configuration comprises at least one of a model training configuration, a model inference configuration, a model deployment configuration, a model update configuration, or a model monitoring configuration; or
the model attribute configuration comprises at least one of an input configuration, an output configuration, a model structure configuration, an interface configuration, or a training rule configuration.

15. The training method according to claim 10, wherein:
the training data collection configuration comprises at least one of a collection object or a collection method; or,
the training data collection configuration comprises a configuration for uplink measurement of a reference signal.

16. The training method according to claim 10, wherein the configuration signaling is any one of downlink control information of a physical layer, a control unit of a media access layer, or radio resource control signaling.

17. The training method according to claim 1, wherein the distributed learning is federated learning or two-sided model training.

18. The training method according to claim 1, wherein the model is a positioning model.

19-28. (canceled)

29. A model training method, comprising:
sending, by a terminal, a first message to a base station, wherein the first message comprises training information of a model deployed on the terminal; and
receiving, by the terminal, a second message sent by the base station, wherein the second message comprises training configuration information of the model.

30. The model training method according to claim 29, wherein the training configuration information comprises at least one of a parameter update indication or a convergence condition update indication, or comprises a training stop indication.

31. The model training method according to claim 29, wherein the first message and the second message are control channel signaling and are scrambled with a scrambling sequence, and the scrambling sequence is determined according to at least one of a model function, a model identity, a training mode, or a training group to which the terminal belongs.
